(19) United States
(12) Patent Application Publication
(10) Pub. No.: US 2009/0037210 A1
(43) Pub. Date: Feb. 5, 2009

(54) SYSTEM AND METHOD FOR REAL TIME MONITORING OF DIGITAL CAMPAIGNS

(76) Inventors: Nir Shimoni, New York, NY (US); Gefen Lamdan, New York, NY (US); Chen Bekor, Ra'anana (IL)

Correspondence Address: Pearl Cohen Zedek Latzer, LLP, 1500 Broadway, 12th Floor, New York, NY, 10036, US

(21) Appl. No.: 12/170,564

(22) Filed: Jul. 10, 2008

Related U.S. Application Data
(60) Provisional application No. 60/935,171, filed on Jul. 30, 2007.

(51) Int. Cl. G06Q 99/00

(52) U.S. Cl. 705/1

(57) ABSTRACT

A system method and apparatus for providing a presentation of a status and progress of a digital campaign to a user. Information pertaining to a plurality of digital campaigns may be obtained from a plurality of advertising or publishing objects. A plurality of delta parameters may be computed according to such information. A plurality of KPI parameters may be computed based on the delta parameters and may further be used to provide a graphical representation of various aspects pertaining to a plurality of digital campaigns. Other embodiments are described and claimed.

### CROSS REFERENCE TO RELATED APPLICATIONS

This application claims the benefit of U.S. Provisional Patent Application No. 60/935,171, filed on Jul. 30, 2007, which is incorporated in its entirety herein by reference.

### BACKGROUND OF THE INVENTION

Digital campaigns have become, and are likely to remain an important tool of the advertising industry. The internet in particular serves as a media for various digital campaigns. The infrastructure required to support a modern digital campaign comprises sophisticated software and hardware necessary in order to design, launch, track and/or otherwise maintain large scale campaigns. Advancements in tools and technology enable campaign launchers and/or managers to quickly respond to various conditions and circumstances. Such conditions and/or circumstances may vary according to time, location, trends and/or according to other parameters. Such variance may dramatically influence an ongoing campaign. Accordingly, an ability to track, in real time, a progress of a digital campaign may be crucial to the success of the campaign. There is a need for a system and/or method to enable online, real time tracking of digital campaigns.

### SUMMARY OF EMBODIMENTS OF THE INVENTION

According to embodiments of the invention, information pertaining to a digital campaign may be collected from advertising objects. According to embodiments of the invention, such information may be used to compute a number of delta parameters reflecting a change in values associated with various parameters. According to embodiments of the invention, delta parameters may be used to compute respective KPI parameters. According to embodiments of the invention, KPI parameters may be used to generate a graphical representation of a progress, status or other applicable aspects of a digital campaign.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1A is a schematic block diagram according to embodiments of the invention;

FIG. 1B is a schematic time-event flow chart according to embodiments of the invention;

FIG. 2 is a schematic block diagram according to embodiments of the invention;

FIG. 3 is a schematic block diagram according to embodiments of the invention; and

FIGS. 4A and 4B are example screen shots according to embodiments of the invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. For example, “a plurality of stations” may include two or more stations.

Unless explicitly stated, the method embodiments described herein are not constrained to a particular order or sequence. Additionally, some of the described method embodiments or elements thereof can occur or be performed at the same point in time.

Although embodiments of the invention are not limited in this regard, discussions utilizing term “delta parameter” may refer to any difference, variance or change. For example, a delta parameter associated with the numbers 7 and 4 may be 3, computed as 7−4=3. A delta parameter associated with the hours 10:45 and 10:30 may be 15 minutes. A delta parameter may assume any applicable units, e.g., an integer, a time unit, or it may be a ratio of two or more quantities.

The terms “advertising object” or “publishing object” used in this patent specification should be expansively and broadly construed to include any type of digital information that may be stored, conmunicated, executed or otherwise manipulated by a computer. For example, an advertising or publishing object may comprise or may be associated with an application, a program code, a shell, cshell or java script, a java code or script. An advertising or publishing object may further comprise or be associated with a file containing image information, multimedia information or text. An advertising object may cause a banner or other graphics to be displayed on a computing device display or utilize other computing or peripheral resources such as audio devices, network devices, storage devices etc. An advertising or publishing object may interact with a user. For example, a banner presented to a user by an advertising object may enable a user to interact with an advertising object. An advertising or publishing object may interact with applications and/or resources on a local computing device and/or applications and/or resources on remote computing devices, for example, over a wired or wireless communication network. The terms “advertising object” and “publishing object” may be used interchangeably in this patent application specification.

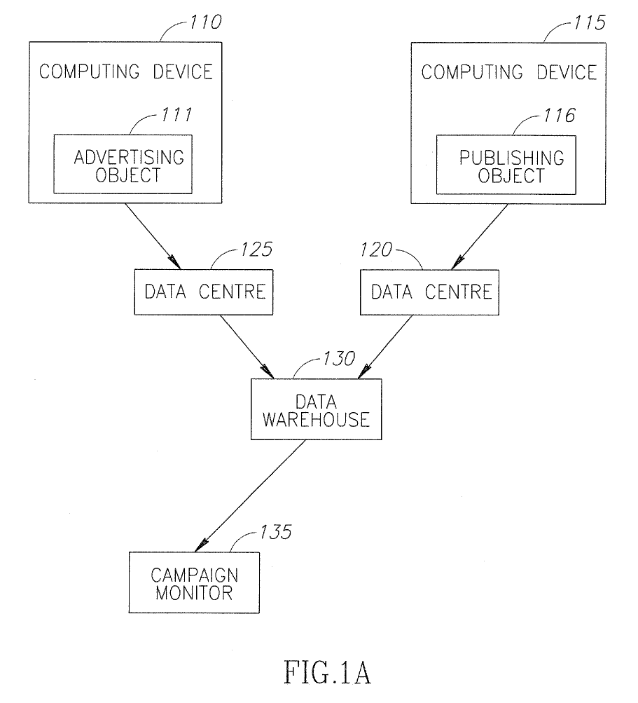

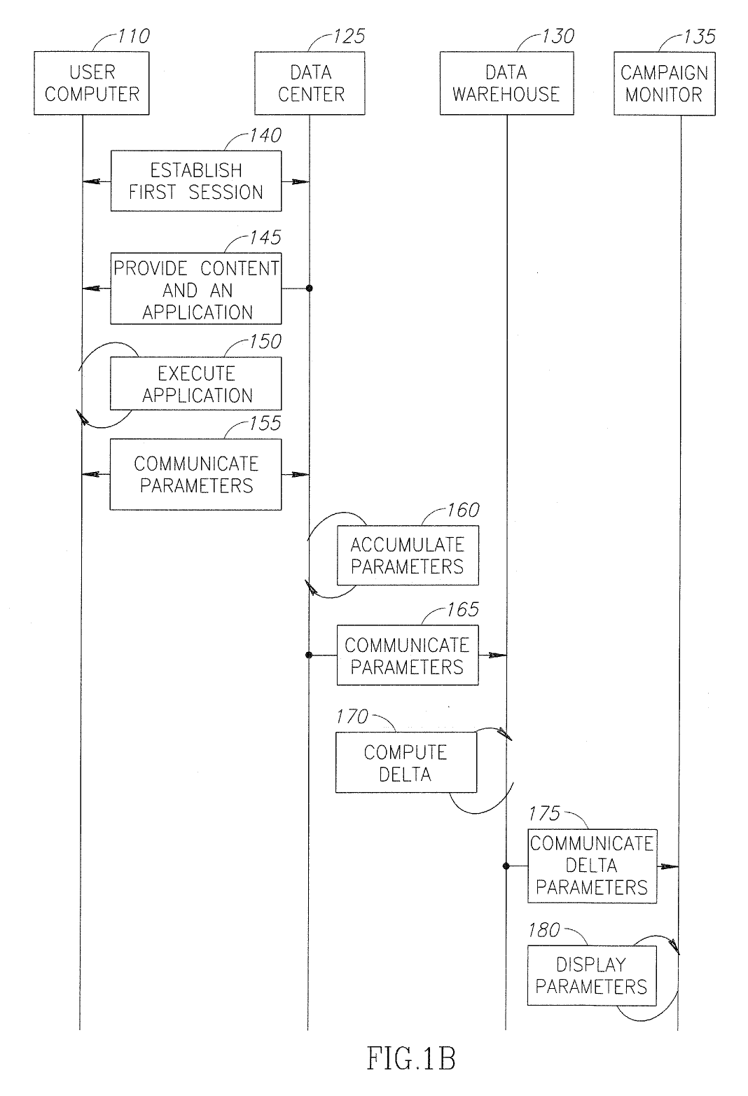

Reference is made to FIG. 1A showing some exemplary components of a typical environment according to embodiments of the invention. According to embodiments of the invention, computing devices 110 and 115 may be any applicable computing devices on which advertisements or content may be displayed, for example, personal computers operated by users. For example, according to embodiments of the present invention, computing devices 110 and 115 may include components such as, but not limited to, a plurality of central processing units (CPU) or any other suitable multi-purpose or specific processors or controllers, a plurality of input units, a plurality of output units, a plurality of memory units, and a plurality of storage units. Computing devices 110 and 115 may additionally include other suitable hardware components and/or software components. In some embodiments, computing devices 110 and 115 may include or may be, for example, a personal computer, a desktop computer, a mobile computer or phone, a laptop computer, a notebook computer, a terminal, a workstation, a server computer, a Personal Digital Assistant (PDA) device, a tablet computer, a network device, or any other suitable computing device.

According to embodiments of the invention, advertising object 111 and publishing object 116 may be any applicable advertisements or content displayed or otherwise presented on a computing device such as computing devices 110 and/or 115. For example, advertising object 111 and publishing object 116 may be advertisements provided over a network, such as the Internet, for example, a banner filling an advertising spot in a web page. According to embodiments of the invention, advertising object 111 and publishing object 116 may comprise or be associated with executable code, pre-compiled code, script or application. For example, a pre-compiled code or script, e.g., java code or script may be associated with advertising object 111 and publishing object 116. Such pre-compiled code or script may be executed by a web browser. According to embodiments of the invention, data centers 120 and 125 may be any applicable data centers, possibly comprising a number of computing devices (not shown) capable of communicating with computing devices 110 and 115 as shown.

According to embodiments of the invention, code, pre-compiled code, script or application embedded in and/or associated with advertising object 111 and publishing object 116 as described above may communicate with one or more applications hosted by one or more computing devices in datacenters 125 and/or 130. For example, a program or pre-compiled code or script associated with advertisement 125 may establish a session with an application hosted by a computing device in datacenter 125 and may further communicate with such application. According to embodiments of the invention, such program or pre-compiled code or script may communicate various information, parameters or content to the application in datacenter 125. For example, a program associated with advertisement 116 may provide an application in datacenter 120 with information pertaining to an interaction of a user with an associated advertisement. Such information may comprise an indication of whether a user has been presented with a banner or other content, whether a user has further clicked on or otherwise interacted with a banner or any other applicable information. Although only two exemplary computing devices and associated advertisements are shown as well as only two exemplary datacenters, according to embodiments of the invention, any number of computing devices such as computing devices 110 and 115 displaying any applicable number of advertisements such as advertising object 111 and publishing object 116 may communicate with any number of datacenters such as datacenter 125 and datacenter 120.

According to embodiments of the invention, data warehouse 130 may comprise any number of computing and storage devices. Typically, data warehouse 130 may be equipped to receive, store and communicate large amounts of data or information. According to embodiments of the invention, datacenter 125 and datacenter 120 may communicate information received from computing devices 110 and 115 as described above to data warehouse 130. According to embodiments of the invention, possibly in addition to storing received information, an application hosted by a computing device in data warehouse 130 may communicate some of the information received by data warehouse 130 to campaign monitor 135. According to embodiments of the invention, campaign monitor 135 may present such information to a user. Campaign monitor 135 will be described below.

Reference is made to FIG. 1B showing a time-event flow chart according to embodiments of the invention. According to embodiments of the invention and as shown by block 140, a session may be established between a user computer and a computer or server in a datacenter. For example, such session may be established as a result of a user operating computer 110 pointing his web browser to a web site hosted by a computer located in datacenter 125. According to embodiments of the invention and as shown by block 145, possibly in addition to other content, one or more advertising objects may be communicated to computer 110. According to embodiments of the invention, such advertising objects may be or comprise an application as described above. Such application may be a pre-compiled code or script such as java code or script embedded in or otherwise associated with the advertisement. According to embodiments of the invention and as shown by block 1503 executable code associated with an advertising object communicated as shown by 145 may be executed on computer 110.

According to embodiments of the invention, an advertisement object communicated from a web server (e.g., a web server in data center 125) to a user computer (e.g., user computer 100) may execute code, interact with a user, interact with the web server or interact with any other computing device. According to embodiments of the invention and as shown by block 155, when an application, possibly associated with an advertising object and communicated as shown by 145 is executed it may communicate various parameters to a computer in datacenter 125. According to embodiments of the invention, such parameters may be an indication that an associated advertisement has been presented to a user. According to embodiments of the invention, such parameters may further comprise additional information, for example, an indication that a user has interacted with the associated advertisement. According to embodiments of the invention, the application provided as shown by block 145 may be configured to track and report an interaction of a user with an associated advertisement or any other applicable conditions or aspects pertaining to the advertisement. According to embodiments of the invention and as shown by block 160, parameters such as those communicated as shown by block 155 may be collected by a computer in datacenter 125. For example, parameters from any number of computers such as computer 110 may be collected and possibly grouped according to various criteria, e.g., advertisement or banner identification. According to embodiments of the invention, accumulating parameters as shown by block 160 may serve to increase efficiency. For example, rather than communicating parameters as they are received as shown by block 155, a predefined amount of such parameters may be accumulated and/or a predefined period of time may be allowed to elapse before further communicating them as shown by block 165.

According to embodiments of the invention and as shown by block 165, parameters received as shown by block 155 may be communicated to a data warehouse, e.g., data warehouse 130. According to embodiments of the invention, a large number of computers located in data centers such as data center 125 may communicate parameters to a data warehouse such as data warehouse 130. According to embodiments of the invention and as shown by block 170, a delta parameter may be computed. According to embodiments of the invention, a delta parameter may be computed by comparing, subtracting or any other applicable manipulation of parameters communicated as shown by block 165 and/or parameters previously communicated or otherwise obtained by data warehouse 130. For example, a number of impressions pertaining to a specific banner, campaign or advertiser communicated as shown by block 165 may be compared with the number of impressions pertaining to the same campaign or advertiser previously received. Accordingly, a number of impressions associated with a time period that elapsed between the previous communication and the current communication of a number of impressions parameter may be derived. According to embodiments of the invention, the parameters communicated as shown by block 165 may further be stored and used to compute a delta parameter when a subsequent communication of such parameters is received. According to embodiments of the invention, a number of delta parameters may be computed as shown by block 170, for example, a delta parameter may be computed for a (possibly very large) number of advertising objects, campaigns, or other classes or categories. According to embodiments of the invention, delta parameters may be computed for any applicable quantity, group, class or association.

According to embodiments of the invention and as shown by block 175, computed delta parameters may be communicated to campaign monitor 135. According to embodiments of the invention and as shown by block 180, communicated parameters may be displayed to a user by campaign monitor 135 as described below.

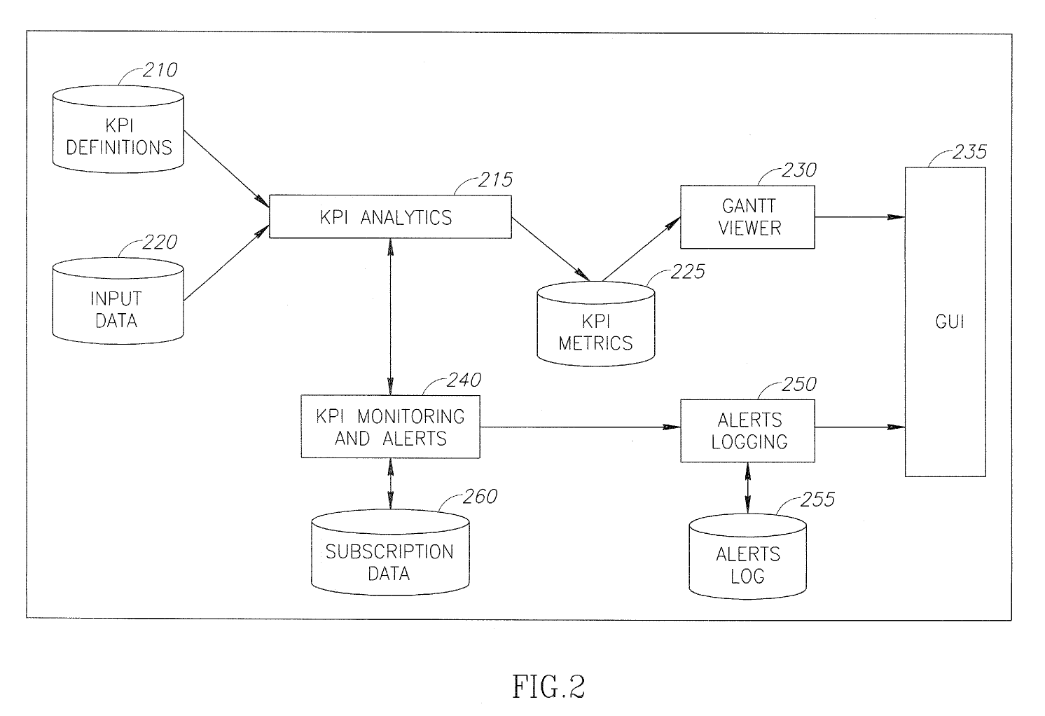

Reference is made to FIG. 2 showing some exemplary components of a campaign monitor according to embodiments of the invention. According to embodiments of the invention, KPI definitions 210, input data 220, subscription data 260, KPI metrics 225 and alerts log 255 may be or may comprise any applicable storage infrastructure. For example, these storage modules may be a hard drive, a removable media, USB storage device, network storage device, FLASH storage device or a RAM media. According to embodiments of the invention, some or all of the above mentioned storage modules may share one or more physical storage devices. According to embodiments of the invention, KPI analytics module 215, Gantt viewer module 230, alerts logging module 250 and KPI monitoring and alerts module 240 may be software modules executable on a computing device, hardware modules, firmware modules or any combination of the preceding. According to embodiments of the invention, components comprising campaign monitor 135 as shown in FIG. 2 may be hosted or associated with any applicable number of computing devices. For example, components comprising campaign monitor 135 as shown in FIG. 2 may be hosted by, associated with or connected to a single computing device such as a server or they may be hosted by, associated with or connected to a number of computers capable of communicating over a suitable communication infrastructure.

According to embodiments of the invention, campaign monitor 135 may comprise KPI analytics module 215. According to embodiments of the invention, KPI analytics module 215 may define and calculate KPI values, metrics, parameters and states. According to embodiments of the invention, an exemplary KPI parameter may be a click through rate (CTR). As known in the art, CTR may be calculated based on a number of banners or other interactive content delivered and a number of actual clicks associated with such content. Information pertaining to clicks or other interaction with content may be calculated and/or presented in more than one way. For example, an accumulative number of interactions such as mouse clicks may be calculated, for example, an accumulative number of clicks since the beginning of the relevant campaign. A rate, e.g., CTR, may be calculated by dividing an accumulative number of interactions or mouse clicks by a time duration, for example the duration of time since a beginning of a campaign to current time.

According to embodiments of the invention, an interaction measure or rate may be different from a CTR. According to embodiments of the invention, an interaction may comprise operations other than actually accessing a site of the relevant advertiser. For example, a banner may enable a user to play a game or view additional items before or even without interacting with the advertiser's site and engaging in a purchasing process. The information that a user has interacted with such banner may be valuable for an advertiser, for example, in order to improve the banner by making it more attractive for interaction. According to embodiments of the invention, such interaction measure and rate may be collected by module 215 or other modules comprising campaign monitor 135.

Other KPI parameters or metrics may by an impression or delivery rate that may be computed based on a number of advertisements delivered, presented or exposed to potential customers. For example, the number of advertisements communicated to users computing devices may be counted and presented as a delivery accumulated sum. Such accumulated sum may be divided by time to produce a delivery or impression rate.

According to embodiments of the invention, a return on investment (ROI) parameter may be computed based on revenues collected and relevant investment. For example, information generated upon a completion of a purchase may be communicated from the web site associated with the purchase to campaign monitor 135, possibly via one or more intermediary entities. Such information may be generated and communicated by an application, a program code, a script, java script java code or any applicable means possibly installed and configured by the site manager or owner. Information indicating actual purchases may be related to information such as cost of an advertising campaign and accordingly, a ROI parameter may be computed by module 215 or other modules of campaign monitor 135.

Yet other KPI or other metrics computed or otherwise derived by KPI analytics module 215 may be delivery measures of advertisements, user engagements with advertisements metrics, various performance metrics of a campaign and/or execution of a campaign. According to embodiments of the invention, various other KPI metrics, values or parameters may be defined. For example, complex KPI metrics involving time, location and interdependency between a number of KPI values may be defined.

According to embodiments of the invention, KPI analytics module 215 may use KPI definitions stored in KPI definitions 210 in order to analyze data and calculate KPI values and/or states. According to embodiments of the invention, definitions stored in KPI definitions 210 may be obtained from a user during a configuration session. For example, KPI analytics module 215 may comprise a KPI management module (not shown) that may interact with a user and further enable a user, possibly through a graphical user interface (GUI) module to add, delete, modify or otherwise manipulate KPI definition parameters. According to embodiments of the invention, definitions stored in KPI definitions 210 may be or may comprise any applicable definitions required for a processing and/or calculating KPI parameters. For example, parameters stored in KPI definitions 210 may be thresholds values defining alarm limits, error values or high and low ratings of various KPI parameters.

According to embodiments of the invention, definitions stored in KPI definitions 210 may further include formulas, scripts, algorithms or any other information and/or parameters that may be used for calculations of KPI parameters, metrics, values or states. For example, such definitions may list a number of input parameters that may be used for calculating a specific KPI metric or state. Another example may be a definition of interdependence between a number of KPI metrics. For example, a KPI metric may be calculated or derived according to, or based on, other, possibly previously calculated, KPI metrics or values. According to embodiments of the invention, definitions stored in KPI definitions 210 may pertain to specific categories, entities, procedures or any applicable constraints. For example, KPI definitions stored in KPI definitions 210 may pertain to a specific advertiser, specific or group of publishers, a specific campaign, a specific or duration period of time or any other applicable category parameter.

According to embodiments of the invention, KPI analytics module 215 may calculate KPI values according to data retrieved or otherwise obtained from input data 220. According to embodiments of the invention, information and/or data stored in input data 220 may be received or otherwise obtained from a data warehouse such as data warehouse 130. According to embodiments of the invention, such data may further originate from code, pre-compiled code, scripts or programs associated with advertisements as described above. According to embodiments of the invention, information or data in input data 220 may be updated according to any time resolution. For example, data in input data 220 may be updated in real-time or it can be updated every minute, five minutes, fifteen minutes, one hour or on a daily basis. According to embodiments of the invention, an application or module in data warehouse 130 may communicate data to be stored in input data 220 according to a predefined interval. Alternatively, KPI analytics module 215 may retrieve new data from a data warehouse or other applicable source every predefined time interval or KPI analytics module 215 may retrieve new data when a request for a calculation of a new set of KPI metrics is received.

According to embodiments of the invention, KPI analytics module 215 may examine a time stamp associated with data obtained from input data 220 and may further select data for processing according to such time stamp. According to embodiments of the invention, such time stamp may be associated with data in input data 220 storage when data is stored in input data 220 storage. Alternatively, according to some embodiments of the invention, a time stamp may be associated with data at earlier stages. For example, an application in data warehouse may associate a time stamp to data communicated to campaign monitor 135. According to embodiments of the invention, any other applicable module manipulating the data may associate or manipulate a time stamp pertaining to the data.

According to embodiments of the invention, KPI analytics module 215 may store calculated KPI values and metrics in KPI metrics 225. According to embodiments of the invention, a time stamp may be associated with KPI metrics stored in KPI metrics 225. According to embodiments of the invention, module 215 may calculate a time stamp or may alternatively be provided with a time stamp. For example, a time stamp may be associated with data received from data warehouse 130 and stored in input data 220. As will be described below, a time stamp associated, and possibly stored, with KPI metrics may be used, for example by Gantt viewer 230, in order to correlate a presentation of various aspects of a campaign with time.

According to embodiments of the invention, KPI analytics module 215 may calculate KPI values according to, or with respect to various categories, associations, levels or parameters. For example, KPI values, metrics and/or states may be computed for a specific advertiser, specific or group of publishers, a specific campaign or any other applicable category, identity or parameter. According to embodiments of the invention, module may further store computations, results and/or any other relevant or applicable information in KPI metrics storage 225.

According to embodiments of the invention and as shown by block 240, campaign monitor 135 may comprise KPI monitoring and alerts module 240. According to embodiments of the invention, KPI monitoring 240 may periodically trigger or otherwise cause KPI analytics module to calculate KPI metrics, parameters or values. According to embodiments of the invention, each such calculation may produce additional entries in KPI metrics 225. Additionally, module 215 may provide KPI monitoring and alerts module 240 with calculated KPI metrics or values. For example, each time KPI monitoring and alerts module 240 causes module 215 to compute a set of KPI metrics or parameters module 215 may communicate or return such computed information to KPI monitoring and alerts module 240. According to embodiments of the invention, KPI monitoring and alerts module 240 may track and/or monitor KPI metrics, values and/or parameters. For example, KPI monitoring and alerts module 240 may store a predefined amount or number of previously received KPI information, metrics, values and/or parameters. Module 240 may further compare newly received KPI information, metrics, or values with such stored information. Accordingly, KPI monitoring and alerts module 240 may compute, calculate or derive various parameters or indicators pertaining to trends, developments or other applicable aspects of a digital campaign. For example, KPI monitoring and alerts module 240 may detect a gradual increase in time of a parameter such as exposure rate of an advertisement. Another example may be detecting a decrease in CTR associated with a campaign.

According to embodiments of the invention, KPI monitoring and alerts module 240 may compare or otherwise examine received KPI information as described above with reference to predefined parameters or values. For example, KPI monitoring and alerts module 240 may be provided with threshold, ranges or other scope defining values pertaining to various KPI parameters, metrics or values. Module 240 may further determine whether KPI parameters, metrics or values received, for example from module 215, are within predefined limits, scope or are below or above predefined thresholds.

According to embodiments of the invention, KPI monitoring and alerts module 240 may monitor information from sources other than module 215. For example, content may require an approval of a publisher before it may be uploaded to the publisher's web sites. Such approval may be communicated to campaign monitor 135 as described above and may further be presented to a user as described below. Another parameter or information that may be monitored and presented to a user may be the time when an advertisement or other content associated with a campaign has been first delivered to users. According to embodiments of the invention, a threshold may be set by a user, possibly using GUI module 235 as described below. According to embodiments of the invention, when the number of content objects delivered to users crosses such threshold, module 240 may generate an event that may be delivered to a user notifying the user that the campaign has actually began running.

According to embodiments of the invention, KPI monitoring and alerts module 240 may issue alerts. According to embodiments of the invention, upon detecting a threshold has been crossed, a range has been exceeded or any other applicable condition has been met, KPI monitoring and alerts module 240 may trigger an alert. According to embodiments of the invention, subscription data 260 may store defined conditions, ranges, thresholds or other information that may be used by KPI monitoring and alerts module 240 to determine an alert should be declared. According to embodiments of the invention, upon determining an alert needs to be declared, KPI monitoring and alerts module 240 may communicate an indication of such alert to alert logging module 250. According to embodiments of the invention, such communication may comprise any applicable information pertaining to or associated with the alert. For example, information included with a communication of an alert may be the specific metric and value that caused the alert, a time parameter reflecting the time the alert was declared or any other relevant time and/or any campaign identification information, e.g., publisher identification, advertiser identification etc.

According to embodiments of the invention, an alert, warning or error definitions may be associated with specific users according to various criteria. For example, a first user may wish to be notified if a specific KPI or other metric or parameter reaches a predefined value while a second user may be indifferent to such parameter. Another example may be where a first user considers a specific value of a specific parameter as an error that merits an alert while a second user may consider a much higher value as an error or exception condition. Accordingly, an alert may be declared in association with a first user when certain conditions are met while another alert may be declared for a second user when other conditions or circumstances are applicable.

According to embodiments of the invention, subscription data 260 may store information required in order to determine whether an error or alert should be declared. According to embodiments of the invention, such definitions may be stored in association with users. Accordingly, errors or alerts may be declared in association with users as described above. According to embodiments of the invention, subscription data 260 may further store information defining actions to be taken upon a detection and/or declaration of an error or an alert. For example, an entry in subscription data 260 may define that if a CTR pertaining to a specific campaign decreases below a specific value then a specific user or a group of users should be notified. According to embodiments of the invention, such entry may further define how to notify each user. For example, a first user may be notified through a paging system, while a second user may be notified by an electronic mail system, a phone system or by calling or otherwise activating a predefined application, possibly on a remote computer, for example by a remote procedure call (RPC) mechanism or protocol. According to embodiments of the invention, alerts, errors or warning may be defined for a campaign, an account, a specific advertiser, a specific publisher or any other applicable criteria. For example, a group of users may be associated with a specific campaign and may all be notified upon a detection of error conditions pertaining to the campaign. Alternatively and/or additionally, a group of users may be included in a recipients list associated with a specific advertiser or group of advertisers or accounts. Accordingly, such users may all be notified upon detecting predefined conditions pertaining to the associated campaign. advertiser or any other applicable entity.

According to embodiments of the invention, any applicable aspects of handling an error or alert may be defined in subscription data 260. For example, the format of a message to be sent upon detecting an error to a specific user may be defined. According to embodiments of the invention, alert messages may be formatted by KPI monitoring and alerts module 240 according to extensible markup language (XML), according to embodiments of the invention, an extensible stylesheet language transformations (XSLT) definition form or file may be associated with each defined user, such associated XSLT may enable KPI monitoring and alerts module 240 to format identical alert, error or notification messages differently for different users. According to embodiments of the invention, the content of a message informing a user of an alert, error or other predefined conditions may be defined per user. Accordingly, different user may receive different messages containing different content even when those messages pertain to the same event.

According to embodiments of the invention, communicating notifications or alerts may be time dependent. For example, it may be defined in subscription data 260 that a specific user is to receive notifications or alerts to a first device, e.g., a mobile phone during working hours, to a computer, e.g., by electronic mail during evening hours, receive only specific alerts to a third device during night time and receive no alerts or notifications of any kind during the weekend. Alternatively, notifications or alerts may be delayed or scheduled for future transmission by KPI monitoring and alerts module 240. For example, a definition in subscription data 260 may instruct KPI monitoring and alerts module 240 to delay communicating alerts or other notifications occurring during a predefined period of time to a future time. According to embodiments of the invention, such delay or scheduling may be per user as described above. According to embodiments of the invention, KPI monitoring and alerts module 240 may farther be configured to periodically or otherwise communicate various parameters or information to a predefined recipient list. For example, KPI monitoring and alerts module 240 may communicate a summary of KPI or other monitored and/or calculated metrics to a number of users. According to embodiments of the invention, any number of such communications may be configured. For example, KPI monitoring and alerts module 240 may communicate a summary of CTR values pertaining to a specific campaign to a first user twice a day and an exposure metric pertaining to a second campaign to three other users.

According to embodiments of the invention and as shown by block 250, campaign monitor 135 may comprise alerts logging module 250. According to embodiments of the invention, alerts logging module 250 may receive alerts or other notifications and may further store such information in alerts log 255. According to embodiments of the invention, alerts logging module 250 may further provide GUI module 235 with any information that may be required by GUI module 235 in order to generate a graphical representation of a digital campaign.

According to embodiments of the invention, a graphical representation of a digital campaign generated by GUI module 235 may comprise displaying or otherwise presenting alerts, errors, warnings or notifications pertaining to campaigns. According to embodiments of the invention, alerts logging module 250 may perform any required searches, conversions or any other functionalities required in order to provide required information from alerts log module 255 to GUI module 235. For example, alerts logging module 250 may search storage 255 for all or some information pertaining to a specific campaign or a specific advertiser or search for all entries associated with a specific time period and may further provide GUT module 235 with results of such searches.

According to embodiments of the invention, a graphical representation and/or a presentation of progress, status or other aspects of one or more digital campaigns may be re-generated or updated by GUI module 235 according to a predefined time interval. For example, a user may define that a presentation will be updated every 1, 5 or 15 minutes, every hour or on a daily basis. According to embodiments of the invention, any applicable module may maintain and/or administer such periodic updates. For example, GUI module 235 or KPI monitoring and alerts module 240 may cause KPI analytics module 215 to generate a new set of metrics or parameters according to a predefined time interval value. Accordingly, such newly generated metrics or information may be presented to a user on a periodic basis.

According to embodiments of the invention, campaign monitor 135 may comprise Gantt viewer module 230. According to embodiments of the invention, Gantt viewer module 230 may provide GUT module 235 with an interface to KPI metrics 225. According to embodiments of the invention, Gantt viewer module 230 may perform any required searches, conversions or any other functionalities required in order to provide required information from KPI metrics 225 to GUT module 235. For example, Gantt viewer module 230 may search KPI metrics 225 for all or some information pertaining to a specific campaign or a specific advertiser or search for all entries associated with a specific time period and may further provide GUT module 235 with results of such searches.

According to embodiments of the invention and as shown by block 235, campaign monitor 135 may comprise GUT module 235. According to embodiments of the invention, GUT module 235 may provide a graphical view of campaigns. According to embodiments of the invention, a display or presentation provided by GUT module 235 may be according to time in a manner similar to a Gantt chart as known in the art. According to embodiments of the invention, a display provided by GUT module 235 may comprise time scales or coordinates and may further comprise graphical boxes or other shapes representing campaigns where such shapes or boxes may be rendered such that their location on a display may represent a duration of an execution of the associated campaigns. Such display method may enable a user to quickly determine which of the displayed campaigns are past, e.g., terminated or over, which campaigns are future campaigns and which are currently executing or in progress. According to embodiments of the invention, a shape representing a campaign as described above may further contain various information and/or parameters pertaining to the campaign. For example, up to date KPI or other metrics or parameters may be displayed within a shape representing a campaign, such parameters may be accumulated number of impressions of or interactions with advertisements, an up to date CTR metric etc. Such displayed values may be obtained from Gantt viewer module 230 as described above.

According to embodiments of the invention, various error, warning or notification messages may be rendered within or near a graphical shape or other entity representing a campaign. Such notifications may be errors, warnings and/or notifications provided by KPI monitoring and alerts module 240 and further communicated to alerts logging module 250 as described above. According to embodiments of the invention, GUT module 235 may enable a user to define parameters pertaining to events, notifications and/or error and/or warning notifications. For example, a user may use GUI module 235 to set thresholds according to which events may be processed and errors or warnings are provided or other actions are preformed. For example, a user may set a click through rate threshold below which a warning will be generated and another, possibly lower threshold the crossing of which may generate an error indication. According to embodiments of the invention, any applicable parameter, e.g., any KPI metric or parameter may be associated with thresholds as described above where such thresholds may be configured by a user interacting with GUI module 235.

According to embodiments of the invention, any applicable action may be associated with a respective parameter. According to embodiments of the invention, a user may use GUI module 235 to associate a specific action when specific conditions are met. According to embodiments of the invention, GUT module 235 may communicate settings to module 240 and KPI monitoring and alerts module 240 may use such settings or configuration parameters to generate warnings, error indications or any other indications or notifications. For example, a user may use GUT module 235 to cause module 240 to generate a warning if a specific KPI metric pertaining to a specific campaign maintains a specific value for more than a specific period of time. For example, if an exposure rate of a specific banner associated with a specific campaign is expected to rise within a known period of time then a user may use GUTI module 235 to cause module 240 to generate a warning if the exposure rate of the banner is substantially constant during more than ten hours.

According to embodiments of the invention, graphical shapes representing campaigns may be interactive. For example, clicking on a graphical shape representing a campaign may cause additional information pertaining to the relevant campaign to be displayed. For example, information pertaining to specific publishers may be displayed, e.g., number of exposures per publisher or any other applicable information. According to embodiments of the invention, a time scale or window according to which information is displayed by GUT module 235 may be set by a user. For example, a user may view a campaign's progress, status or other applicable aspects in a resolution of days, hours, minutes or in real-time and may additionally view past events, trends, status or progress by time shifting the display.

According to embodiments of the invention, GUT module 235 may provide a non-linear or variable gradient display. According to embodiments of the invention, information displayed by GUI module 235 may be non-linearly distributed over a region of a display of a computing device. For example, a specific graph may contain values between 1 and 100. According to embodiments of the invention, a region allocated for displaying such graph may be divided such that values between 1 and 5 are displayed over 80% of the region allocated for the graph area and values between 5 and 100 are displayed over the rest of the graph area (20%), thus providing for values between 1 and 5 to be displayed with high resolution and/or sensitivity. According to embodiments of the invention, a number of graphs or other graphical entities, e.g., histograms, pie charts or any applicable graphical entities may be displayed on a single display. According to embodiments of the invention, each such graphical entity may possess its own characteristics, e.g., its own non-linear display attributes as described above.

According to embodiments of the invention, GUI module 235 may enable a user to visually set, alter, modify, define or otherwise manipulate various errors, warnings or notifications limits or conditions. According to embodiments of the invention, GUI module 235 may receive input for such manipulations and may further communicate such input to KPI monitoring and alerts module 240 (possibly via alerts logging module 250). According to embodiments of the invention, KPI monitoring and alerts module 240 may use such input in order to store definitions in subscription data 260 and may further generate alerts or warnings according to such definitions as described above.

According to embodiments of the invention, GUI module may enable a user to custom tailor a display according to various aspects, conditions or interests. For example, a user may elect to omit a specific advertisement from a display of a campaign. For example, a specific advertisement in a multi advertisement campaign may be a test or pilot advertisement, such advertisement may cause the entire campaign to look like it is under performing. According to embodiments of the invention, a user may filter out or dismiss such advertisement from a display of the campaign and thus achieve a more accurate view of the campaign. According to embodiments of the invention, a user may start with an “empty” campaign, namely, a campaign that comprises no displayable components such as advertisements. A user starting off with such “empty” campaign may further populate such campaign with components. According to embodiments of the invention, dismissing components from a populated campaign or populating an initially empty campaign may result in the same campaign display.

According to embodiments of the invention, more than one implementation and/or mode of operation may be possible. According to embodiments of the invention, one such mode or implementation may be a web based implementation or setup. According to such setup or mode, various operations and/or functionalities described with reference to campaign monitor 135 shown in FIG. 2 may be performed by a server. According to such mode, a user application may consist of mainly GUI module 235 described above and an interface module (not shown). Such interface module may enable GUI module 235 to interact with a server. Such interaction may comprise obtaining KPI parameters computed for a specific campaign, updating a notification system and/or updating a KPI definition repository. According to embodiments of the invention, a web based setup may shift the computation load as well as some of the storage load to a remote server. It will be recognized that modules described above, for example, KPI analytics module 215, Gantt viewer module 230, alerts logging module 250 or KPI monitoring module 240 may be arbitrarily distributed, for example, between a remote server located in a data center or else where and a user's computer, located at a work place or home.

According to embodiments of the invention, possibly as part of a desktop application setup, implementation or mode, various information may be stored, for example, on a user's computer. For example, KPI analytics module 215 may locally store KPI metrics according to any applicable time resolution or alerts logging module 250 may locally store any applicable information pertaining to alerts. For example, KPI analytics module 215 may be configured to store KPI or other metrics every 15 minutes, or it may store such information upon a request. Alternatively or additionally, module 215 may store a snapshot of KPI or other metrics once a day. According to embodiments of the invention, information stored at a resolution such as once a day may be used to present long term trends or views while information calculated and stored in KPI metrics 225 every 1, 5, or 15 minutes may be used in order to provide a real time view of an ongoing campaign. According to embodiments of the invention, local storage may be configured according to various parameters. For example, local storage may be configured to occur periodically or it may be configured to occur upon a predefined event such as a specific KPI metric crossing a predefined threshold. Additionally, local storage may be triggered by a user, for example, GUI module 235 may comprise a button enabling a user to cause information pertaining to a specific campaign, a group of campaigns or any other applicable category to be locally stored.

According to embodiments of the invention, such local storage may enable a user to review past events, for example, by providing GUI module 235 with stored information pertaining to previous time. Additionally, such local storage may enable a user to reformat, sort or otherwise manipulate stored information and thus provide or achieve various, possibly different views of the same information. According to embodiments of the invention, locally storing information such as KPI metrics and/or any other applicable information may enable a user to communicate or otherwise transfer such information to other computing devices. For example, a user in possession of such information may send it to another user who may view it, possibly using GUI module 235 on his local computer.

According to embodiments of the invention, possibly in a web based setup, a user may subscribe for notifications with the server applications. According to embodiments of the invention, such subscription may be according to a variety of conditions, parameters or other applicable aspects. For example, a user may subscribe in order to be informed about events, conditions or other aspects pertaining to a specific campaign, a specific advertisement in a campaign, a specific, group or category of error conditions etc. According to embodiments of the invention, as a result of such subscription, messages may be “pushed” to a user's computer, e.g., the user computer may be passive with regard to such messages, the server assumes the task of communicating such messages to the user's computer. According to embodiments of the invention, such messages may further be popped-up on a user's computer display or they may otherwise be noticeably presented, for example, by GUI module 235. According to embodiments of the invention, subscription as described above may be automatic. According to embodiments of the invention, GUI module 235 and/or other modules comprising campaign monitor 135 may cause a subscription to occur when a user selects or otherwise interacts with a specific campaign, advertisement. For example, an interface module (not shown) may be provided by GUI module 235 with information pertaining to user interaction. Such module, when detecting a user is interacting with a specific campaign, advertisement or any other applicable entity may subscribe with a server to receive messages pertaining to the specific campaign or advertisement. Such module may further remove a subscription when it detects a user is no longer interacting with the campaign or advertisement.

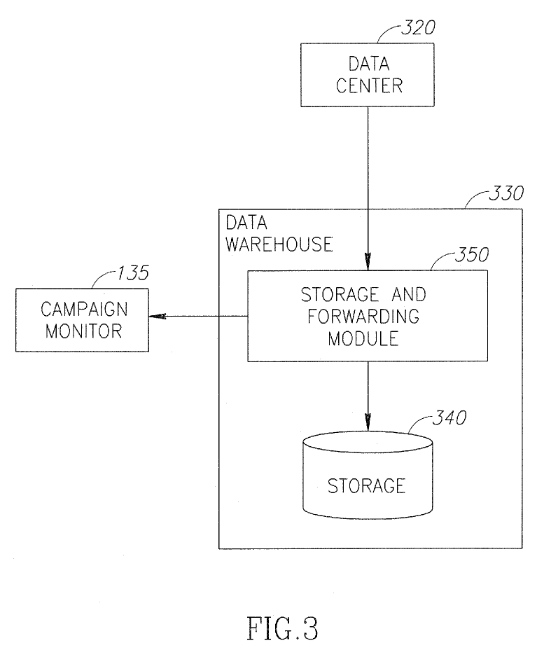

Reference is made to FIG. 3 showing some exemplary components of a typical environment according to embodiments of the invention. According to embodiments of the invention, datacenter 320 may be similar to datacenters 120 and 125 described above. It will be noted that although a single exemplary datacenter is shown, embodiments of the invention are not restricted to any number of such datacenters. Moreover, embodiments of the invention may typically comprise a large number of such datacenters. According to embodiments of the invention, data warehouse 330 may be similar to data warehouse 130 described above. It will be noted that although a single exemplary data warehouse is shown, embodiments of the invention are not restricted to any number of such data warehouses, moreover, according to some embodiments of the invention, a single campaign monitor as shown by block 135 in FIG. 3 may interact with a number of data warehouses such as data warehouse 330. According to embodiments of the invention, data warehouse storage 340 may be any suitable storage device or system. For example, data warehouse storage 340 may be a hard drive, network storage device, an archiving system or a redundant array of independent disks (RAID). Typically, data warehouse storage 340 may be capable of storing large amounts of data, e.g., terabytes.

According to embodiments of the invention, storage and forwarding module 350 may be a plurality of software modules executable on a computing device, a plurality of hardware modules, a plurality of firmware modules or any combination of the preceding. According to embodiments of the invention, storage and forwarding module 350 may be provided with data from one or more datacenters such as datacenter 320. Such data may originate from advertising object 111 and publishing object 116 as described above. For example, such information may comprise indications pertaining to an exposure of advertisements associated with advertising objects, an interaction with advertisements etc. According to embodiments of the invention, information provided by advertising objects may further contain parameters such as an identification of the source advertising object, an identification of the relevant or associated advertising campaign, information pertaining to the web server associated with the source advertising object and/or any other applicable information that an advertising object may obtain or be provided with.

According to embodiments of the invention, storage and forwarding module 350 may associate received or otherwise obtained data with a time stamp. For example, storage and forwarding module 350 may record the time data was received at data warehouse 330 and may further associate such recorded time with received data. According to embodiments of the invention, storage and forwarding module 350 may store received data in storage 340. Such storing by module 350 may comprise storing of data and associated metadata. Examples of metadata that may be stored by storage and forwarding module 350 may be a timestamp, an identification of a publisher associated with the data, an identification of the datacenter associated with the data and/or any other information or parameters that may be obtainable or calculated.

According to embodiments of the invention, storage and forwarding module 350 may compute, calculate or otherwise derive information reflecting a change or difference of various values associated with various parameters, metrics or information. For example, a first communication may comprise an indication of 900 accumulated exposures of a specific banner and a subsequent communication may comprise an indication of 1200 accumulated exposures of the same specific banner. Accordingly, storage and forwarding module 350 may compute a difference of 300 accumulated exposures of the specific banner over the time between the first communication and the second communication. In some embodiments of the invention, a difference in a rate of a parameter may be recorded and sent, thereby further reducing the required bandwidth or communication. For example, if over a 15-minute span 250 views were recorded, and in the subsequent 15-minte span, an additional 250 views were recorded, there may be no update sent because the change in the rate of views is unchanged. In some embodiments, a sensitivity or tolerance threshold may be set, for example, 5%, such that any change of less than 5% from a previous value is not forwarded, and the same value may be assumed from cycle to cycle until the value is changed by more than the tolerance level, at which point the difference parameter may be sent and the value updated.

According to embodiments of the invention, storage and forwarding module 350 may be configured to periodically compute such difference or change for any number of parameters and according to any category, level, group or any other applicable sorting criteria. For example, storage and forwarding module 350 may compute an incremental change, difference or variance of a number of values associated with a respective number of parameters pertaining to a specific advertisement delivered to users by a specific publisher. Other criteria, parameters or classes by which module 350 may compute a difference, change, trend or variance as described may be a campaign, an advertiser or a datacenter. For example, storage and forwarding module 350 may compute a difference or change as described above for all banners associated with a specific publisher, a specific data center or a specific advertiser. According to embodiments of the invention, storage and forwarding module 350 may compute changes, trends or differences as described by manipulating values contained in two or more consecutive data receptions from datacenters. According to embodiments of the invention, storage and forwarding module 350 may store data contained in a first transmission and use such stored data in order to compute a change or difference when a second transmission is received. Such configuration may enable storage and forwarding module 350 to compute changes using only a subset of the accumulated data. Accordingly, computational resources required for computing differences as described above may be substantially less than those that would have been required if storage and forwarding module 350 was to compute such differences by utilizing the entire accumulated data stored in data warehouse storage 340.

According to embodiments of the invention, storage and forwarding module 350 may further store some or all information received from datacenters such as datacenter 320 in storage 340. According to embodiments of the invention, storage and forwarding module 350 may perform any applicable computations based on information stored in storage 340. For example, storage and forwarding module 350 may compute any long term parameters based on information stored in storage 340, for example, provide trends pertaining to days or weeks or to terminated campaigns.

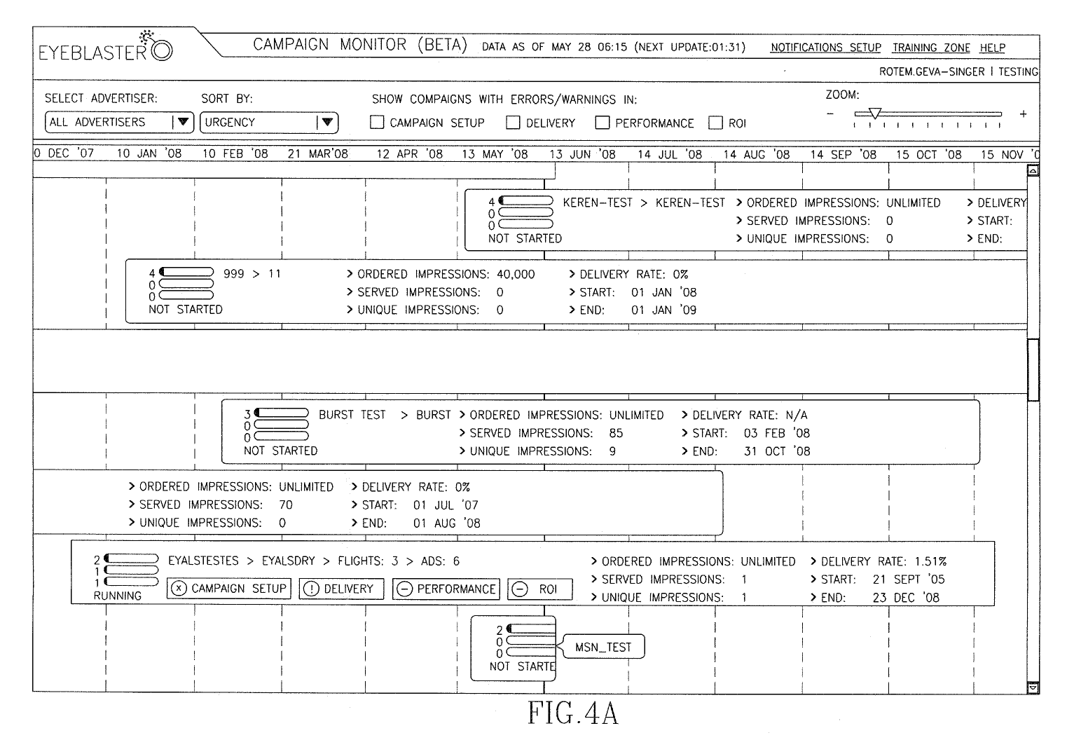

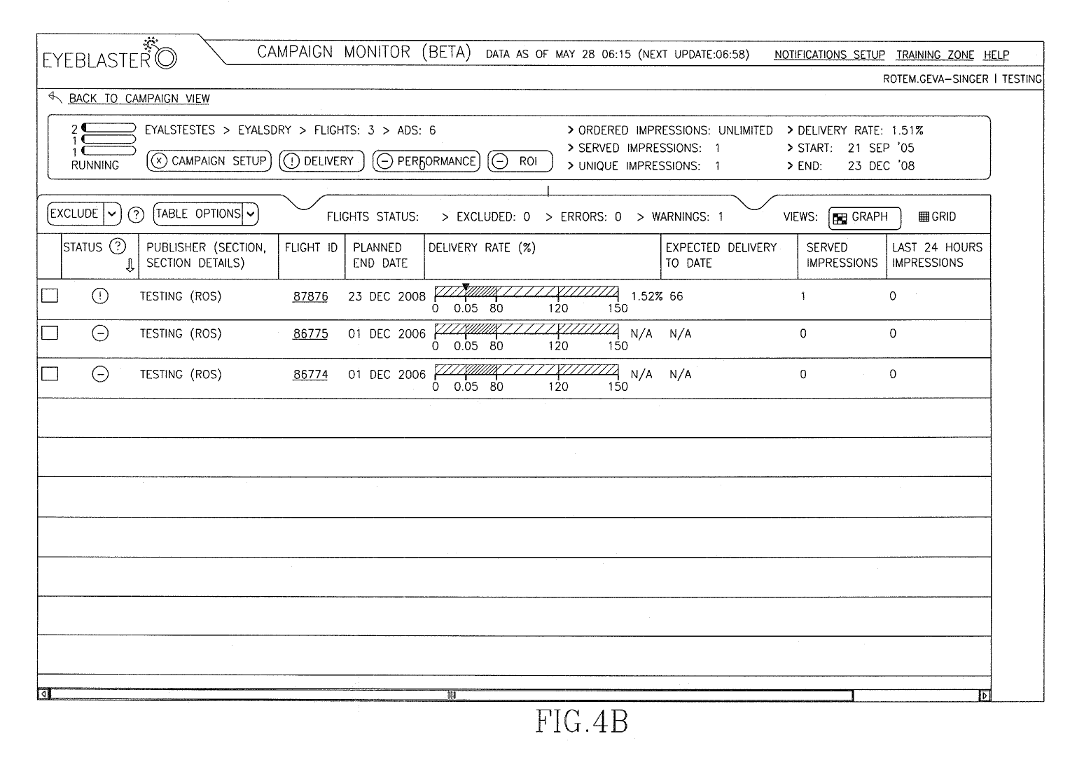

FIG. 4A is an example screen shot of a Gantt chart in accordance with the present invention. As may be observed, each row may represent a campaign arrayed along a horizontal time axis, where the left edge of each row is a begin time of the campaign and the right edge of each row is an end time of the campaign. The scale of the time axis may be adjusted, e.g., zoomed in or out, by the viewer as suitable. The campaigns may be sorted from top to bottom by various criteria, for example, begin time, end time, total duration, urgency, and other criteria. The user may filter the viewed campaigns based on various criteria, for example, view only campaigns with errors in any, some, or all of delivery, execution, performance, ROI, or other KPI. Each bar may include summary information about the campaign, for example, name and code of the campaign, number of ordered impressions, number of served impressions, number of unique impressions, etc.

FIG. 4B is an example screen shot of a detailed view of a campaign in accordance with the present invention. For any campaign on the Gantt chart, further or more detailed information may be obtained, for example, by clicking on a portion of the campaign bar. Further information may include a breakdown of the various KPI set for that campaign, or parts thereof, for example, by publisher, and a graphical representation of the actual KPI of the campaign vis-à-vis the KPI parameters set for the campaign. Thus, it may easily be observed which KPI metrics or parameters are within a normal or expected range, which are in a warning low or high region, and which are in a critical high or low region.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A method for monitoring digital advertising campaigns, the method comprising:
receiving from a plurality of advertising objects information pertaining to a plurality of digital campaigns;
computing a plurality of delta parameters according to said information;
computing a plurality of key performance indicators (KPI) parameters according to said delta parameters; and
providing a graphical representation of said digital campaigns according to said plurality of KPI parameters.

2. The method of claim 1, wherein said graphical representation further comprises displaying at least one parameter selected from the group consisting of: a click through rate, a delivery rate, an interaction rate, a return on investment (ROI) measure, an actual start time of a campaign, an approval of content by a publisher and an accumulated number of delivered impressions.

3. The method of claim 1, wherein said graphical representation is updated according to a predefined time interval.

4. The method of claim 1, wherein said graphical representation comprises presenting aspects pertaining to a plurality of digital campaigns.

5. The method of claim 1, wherein said graphical representation comprises providing an indication pertaining to a detection of an event.

6. The method of claim 5, wherein said event comprises a crossing of a predefined threshold by a value associated with a predefined parameter.

7. The method of claim 6, further comprising adjusting said thresholds.

8. The method of claim 1, further comprising selectively including some of said KPI parameters in said graphical representation of said digital campaigns.

9. The method of claim 1, wherein said graphical representation is non-linear.

10. A system for monitoring digital advertising campaigns comprising:
a first module to receive from a plurality of advertising objects information pertaining to a plurality of digital campaigns and to compute a plurality of delta parameters according to said information;
a second module to use said plurality of delta parameters to compute a plurality of key performance indicators (KPI) parameters according to said delta parameters; and
a graphical user interface (GUI) module to generate a graphical representation of a digital campaign according to said plurality of KPI parameters.

11. The system of claim 10, wherein said graphical representation further comprises displaying at least one parameter selected from the group consisting of: a click through rate, an impression rate, a delivery rate, an interaction rate, a return on investment (ROI) measure, an actual start time of a campaign, an approval of content by a publisher, an accumulated number of click through events, an accumulated number of impressions, an accumulated number of deliveries and an accumulated number of interactions with delivered content.

12. The system of claim 10, wherein said graphical representation is updated according to a predefined time interval.

13. The system of claim 10, wherein said graphical representation comprises presenting aspects pertaining to a plurality of digital campaigns.

14. The system of claim 10, wherein said graphical representation comprises providing an indication pertaining to a detection of an event.

15. The system of claim 14, wherein said event comprises a crossing of a predefined threshold by a value associated with a predefined parameter.

16. The system of claim 10, wherein said second module is configured to generate an indication upon detecting a predefined condition.

17. The system of claim 16, wherein said condition comprises a crossing of a predefined threshold by a value associated with a predefined KPI parameter.

18. The system of claim 16, wherein said condition comprises a crossing of a predefined threshold by a value associated with a predefined delta parameter.

19. The system of claim 15, further configured to enable a user to define said thresholds.

20. The system of claim 10, wherein said GUT module is configured to provide a non-linear representation of a digital campaign.

21. The system of claim 10, wherein said GUT module is further configured to selectively include some of said KPI parameters in a graphical representation of a digital campaign.

22. The system of claim 10, wherein said first module is executed on a first computing device and said second and third modules are executed on a second computing device.

23. The system of claim 10, wherein said first and second modules are executed on a first computing device and said third module is executed on a second computing device.
